(19) United States
(12) Patent Application Publication
(10) Pub. No.: US 2021/0093027 A1
(43) Pub. Date: Apr. 1, 2021

(54) Recovery Wear

(71) Applicant: ANTHONY LADAS, Batavia, IL (US)

(72) Inventor: ANTHONY LADAS, Batavia, IL (US)

(21) Appl. No.: 16/590,236

(22) Filed: Oct. 1, 2019

(51) Int. Cl. A41D 27/08; G09F 3/02

(52) U.S. Cl. CPC A41D 27/08; G09F 3/02; G09F 2003/0282; G09F 2003/0208; G09F 2003/0202

(57) ABSTRACT

A garment that can be used to enhance the safety of injured or convalescing people. The garment includes indicia which indicates that a person is either injured or convalescing. The indicia is positioned on the garment so as to overlay the affected or injured area of the user's body. In one aspect of the invention, garments are given to outpatients as they are discharged from the hospital. These garments have indicia positioned at the site of the persons' injury or surgery.

### 1. FIELD OF THE INVENTION

The present invention relates to apparel. More particularly, the invention relates adding indicia to a garment to reduce further injury to a convalescing person.

### BACKGROUND OF THE INVENTION

Garments for patients or people convalescing from injury are well known. Typically, these garments eschew style for functionality. For example, the standard hospital gown uses a simple drawstring for closure to avoid the need to unfasten multiple closures.

Crutches, canes, or other ambulatory aids make it obvious that a person is either injured or handicapped, the mere appearance of these aids puts passersby on notice and the person using the aid is often given a wide berth to avoid jostling and possibly reinjuring the person. These aids are therefore effective to give notice to people that the wearer is injured or otherwise vulnerable.

Additionally slings, neck braces, soft casts, etc., also put people on notice of a convalescing individual without the need for any indicia or other markings. For example, US patent application number 20190125568 shows a shoulder sling. The sling can include indicia thereon to warn others that the shoulder is injured. There are several problems with this arrangement. First, the mere fact that the person is wearing a shoulder sling calls attention to the fact that the person is injured, this makes the indicia redundant. Secondly, because the sling is relatively small, any indicia thereon is correspondingly small and therefore not noticeable until within about 10 feet, which may be too late for e.g., a cyclist passing the wearer. Finally, the wearer may have a shoulder injury that does not require a sling, and this item of clothing is too restricting to be worn simply too warn others.

Accordingly, there is a need for a garment that can be used to enhance the safety of injured or convalescing people. The garment includes indicia which indicates that a person is either injured or convalescing. The indicia is positioned on the garment so as to overlay the affected or injured area of the user's body. In one aspect of the invention, garments are given to outpatients as they are discharged from the hospital. These garments have indicia positioned at the site of the persons' injury or surgery.

### SUMMARY OF THE INVENTION

It is a major object of the invention to provide a garment for convalescents.

It is another object of the invention to provide a garment for convalescents which can alert others that the wearer is injured or convalescing.

It is another object of the invention to provide a garment for convalescents with indicia pre-printed thereon.

It is another object of the invention to provide a garment for convalescents where portions of the garment are adapted to receive a substrate.

It is another object of the invention to provide a garment for convalescents where portions of the garment are adapted to receive a substrate with warning indicia imprinted thereon.

### BRIEF DESCRIPTION OF THE DRAWINGS

FIG. 1 shows a plan view of a garment modified in accordance with the inventive concept.

FIGS. 2-5 show the inventive garment illustrating the various positions and orientations of the warning indicia.

FIG. 6 shows a removable decal which can be positioned on the garments shown in FIGS. 1-5.

### DETAILED DESCRIPTION

The present invention is directed to a garment, and a method of using such a garment. The garment is useful to safeguard injured persons, outpatients, and other convalescing individuals. The purpose of the garment is to advise or alert others who come within the proximity of the wearer that the person is injured or recovering so as to avoid further injury which might occur if the injured person is jostled or bumped. The garment could be especially useful if the wearer becomes unconscious and is therefore unable to communicate the injury to others. This situation could arise should the person be in an accident, the garment serving to advise emergency personnel that the wearer is injured.

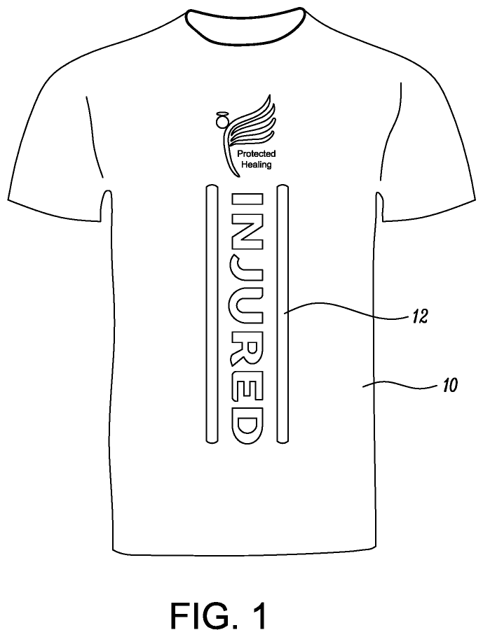

Referring now to FIGS. 1-5, representative garments employing the inventive technique are shown. In the examples shown, the garments are a t-shirt and a pair of pants, but any garment can be used to practice the invention, provided the garment covers the injured area.

As can be seen in FIG. 1, a T-shirt 10 with indicia 12 thereon is shown. The indicia 12 can be any word, symbol, or combination of words and symbols which can indicate that a person is injured. The indicia 12 provides an alert to persons in close proximity to the wearer. It can be appreciated that the invention has particular utility for wearers with communication issues or mentally challenged. In the examples shown the indicia 12 is the word “INJURED” which covers a major portion of the front of the T-shirt to be visible from a long distance. Bright and contrasting colors are preferably used to draw attention to the fact that the indicia 12 is not mere ornamentation. The indicia 12 could be printed onto the shirt using any known technique for printing onto cloth. Alternatively, the garment 10 may come with a removable decal with the indicia 12 pre-printed thereon so that the wearer can use the garment 10 after convalescing without the indicia 12.

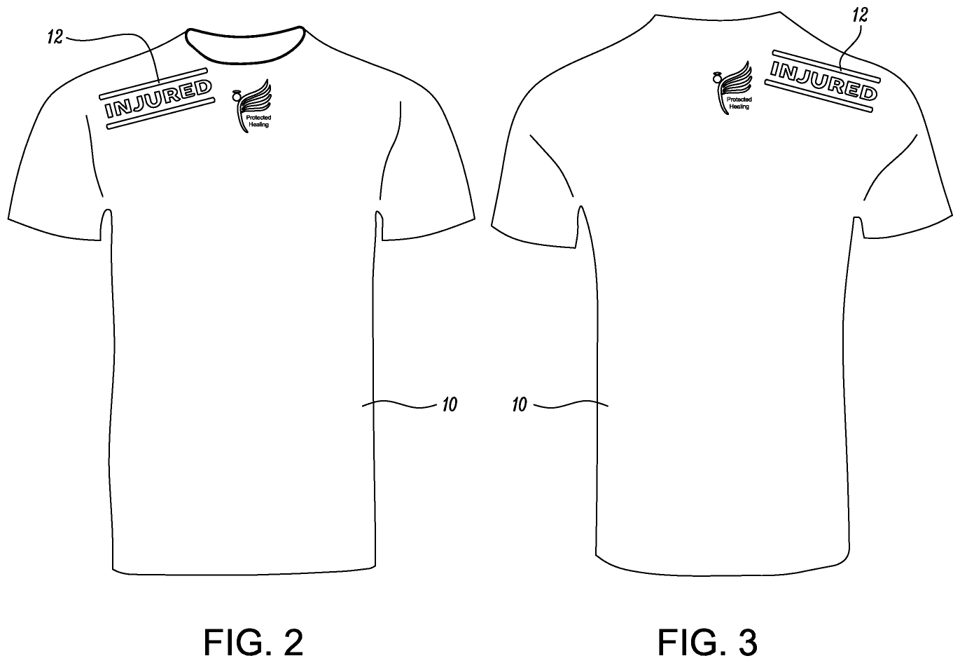

FIGS. 2 and 3 illustrate how the indicia 12 may be positioned to precisely identify a smaller injured area. The indicia 12 is much smaller in relation to the size of the garment 10 and is positioned directly over the affected area, as opposed to the more general positioning shown in FIG. 1. This garment 10 has particular utility in an indoor setting, as the wearer will be in close enough proximity to others that they can perceive the alerting indicia 12.

FIGS. 4 and 5 show a pair of pants 22 with indicia 12 positioned thereon. The indicia 12 can of course be positioned on the right or left leg, back or front panel of the pants. As with the garment 10 of FIG. 1, smaller indicia 12 can be used especially for indoor settings.

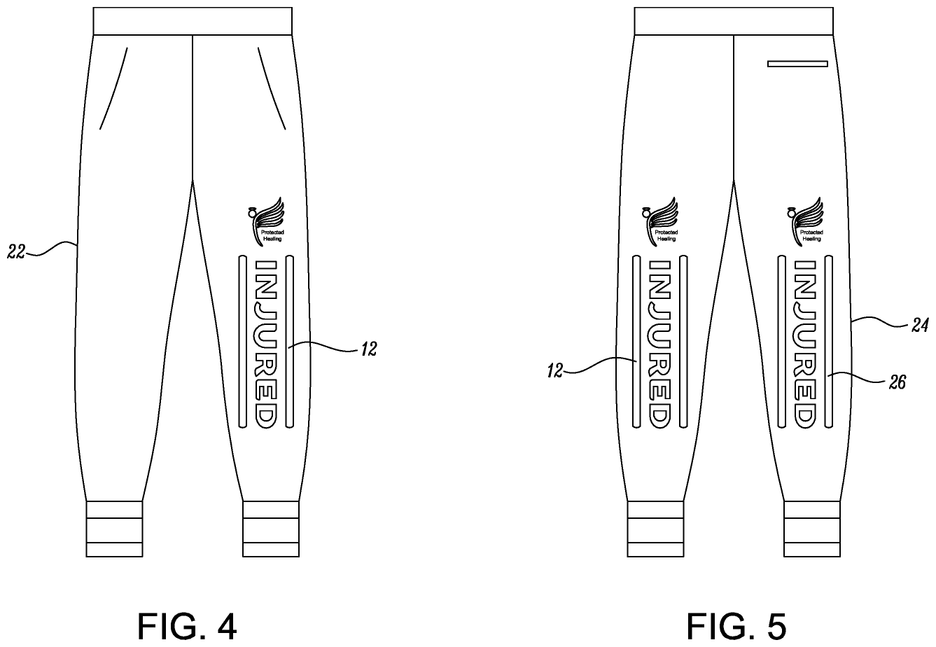

Alternatively to printing the indicia 12, a decal or other substrate 24 may be used. The decal 24, as shown in FIG. 6 may be of the peel and stick variety and may be sized and positioned as described above. Also, garments 10, 22 may have areas 26 specially prepared for receiving a substrate 24 having, e.g., hook or loop material positioned thereon, with indicia 12 on the opposing side. Thus, each garment 10, 22 would have multiple substrate receiving areas.

One possible use of the indicia 12 is as a “discharge garment” for patients leaving the hospital, the garment clearly indicating to e.g., an orderly, where the person is injured. Again, in the case of a non-communicative patient, the garment can alert others which may help prevent further injury. The garment 10, 22 could also be used to identify (before surgery) a part of the body requiring surgery.

It is to be understood that the present invention is not limited to the sole embodiment described above, but encompasses any and all embodiments within the scope of the following claims:

I claim:

1. A method of protecting a convalescing person comprising the steps of:
identifying an injured area on the person;
providing a garment to cover the injured area;
positioning an alerting message on the garment where the positioning of the message corresponds to the injured area.

2. The method of claim 1 where said garment has a number of substrate receiving areas thereon.

3. The method of claim 2 wherein said substrate receiving areas receive a substrate with said alerting message positioned thereon.
